(19) United States
(12) Patent Application Publication
(10) Pub. No.: US 2023/0138109 A1
(43) Pub. Date: May 4, 2023

(54) OCCUPANCY BASED METHOD OF OPERATING A HEAT PUMP AIR CONDITIONER UNIT

(71) Applicant: Haier US Appliance Solutions, Inc., Wilmington, DE (US)

(72) Inventors: Timothy Scott Shaffer, La Grange, KY (US); Joshua Duane Longenecker, Louisville, KY (US)

(21) Appl. No.: 17/513,953

(22) Filed: Oct. 29, 2021

(51) Int. Cl. F24F 11/81; F24F 11/84; F24F 11/86; F24F 1/022; F25B 30/02; F25B 49/02

(52) U.S. Cl. CPC F24F 11/81; F24F 11/84; F24F 11/86; F24F 1/022; F25B 30/02; F25B 49/022; F24F 2120/10

(57) ABSTRACT

An air conditioner unit includes a compressor for circulating refrigerant through refrigeration loop, an indoor fan, and an outdoor fan. A controller is configured to operate the air conditioner unit in a standard mode of operation to heat a room, determine that an occupant is present in the room, and operate the air conditioner unit in an occupant mode of operation in response to determining that the occupant is present in the room. The occupant mode of operation includes adjusting at least one operating parameter of the air conditioner unit to increase a discharge temperature of a flow of indoor air relative to the standard mode of operation.

### FIELD OF THE INVENTION

The present disclosure relates generally to air conditioner units, and more particularly to methods of operating heat pump air conditioner units.

### BACKGROUND OF THE INVENTION

Air conditioner or conditioning units are conventionally utilized to adjust the temperature indoors, e.g., within structures such as dwellings and office buildings. Such units commonly include a closed refrigeration loop to heat or cool the indoor air. Typically, the indoor air is recirculated while being heated or cooled. A variety of sizes and configurations are available for such air conditioner units. For example, some units may have one portion installed within the indoors that is connected to another portion located outdoors, e.g., by tubing or conduit carrying refrigerant. These types of units are typically used for conditioning the air in larger spaces.

Another type of air conditioner unit, commonly referred to as single-package vertical units (SPVU) or package terminal air conditioners (PTAC), may be utilized to adjust the temperature in, for example, a single room or group of rooms of a structure. These units typically operate like split heat pump systems, except that the indoor and outdoor portions are defined by a bulkhead and all system components are housed within a single package that installed in a wall sleeve positioned within an opening of an exterior wall of a building. When a conventional PTAC is operating in a cooling or heating mode, a compressor circulates refrigerant within a sealed system, while indoor and outdoor fans urges flows of air across indoor and outdoor heat exchangers respectively.

Certain conventional air conditioner units include a sealed system that is operated as a heat pump for providing a flow of air into the room at a higher temperature than the room temperature. In this regard, a compressor circulates refrigerant through an indoor heat exchanger, an outdoor heat exchanger, and an expansion device such that the refrigerant extracts heat from the outside air and transfers the heat indoors. In general, heat pumps operate in a very efficient operating mode where the temperature difference between the supplied air and the room temperature is relatively small. This may be desirable for improved operating efficiency while also maintaining the target room temperatures. However, the air exhaust stream that is discharged into the room during heat pump operation may be relatively tepid or cool to a room occupant. For example, under certain conditions, as the outside ambient temperatures drop, the temperature of the exhaust stream during heat pump operation may also drop, e.g., resulting in air exhaust stream temperatures below 80° Fahrenheit, which may be perceived as cool to the occupant.

Accordingly, improved air conditioner units and methods of operation would be useful. More specifically, a heat pump air conditioner unit that regulates the use of the heat pump system for improved occupant comfort without unduly sacrificing the efficiency of the unit would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an air conditioner unit for heating a room is provided. The air conditioner unit includes a refrigeration loop including an outdoor heat exchanger, an indoor heat exchanger, and an expansion device, a compressor operably coupled to the refrigeration loop and being configured to urge a flow of refrigerant through the refrigeration loop, an indoor fan for urging a flow of indoor air through the indoor heat exchanger, and an outdoor fan for urging a flow of outdoor air through the outdoor heat exchanger. A controller is operably coupled to the compressor and is configured to operate the air conditioner unit in a standard mode of operation to heat the room, determine that an occupant is present in the room, and operate the air conditioner unit in an occupant mode of operation in response to determining that the occupant is present in the room, the occupant mode of operation comprising adjusting at least one operating parameter of the air conditioner unit to increase a discharge temperature of the flow of indoor air.

In another exemplary embodiment, a method of operating an air conditioner unit is provided. The air conditioning unit includes a refrigeration loop, a compressor, an indoor fan, and an outdoor fan. The method includes operating the air conditioner unit in a standard mode of operation to heat a room, determining that an occupant is present in the room, and operating the air conditioner unit in an occupant mode of operation in response to determining that the occupant is present in the room, the occupant mode of operation comprising adjusting at least one operating parameter of the air conditioner unit to increase a discharge temperature of a flow of indoor air.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an air conditioner unit, with part of an indoor portion exploded from a remainder of the air conditioner unit for illustrative purposes, in accordance with one exemplary embodiment of the present disclosure.

FIG. 2 is another perspective view of components of the indoor portion of the exemplary air conditioner unit of FIG. 1.

FIG. 3 is a schematic view of a refrigeration loop in accordance with one embodiment of the present disclosure.

FIG. 4 is a rear perspective view of an outdoor portion of the exemplary air conditioner unit of FIG. 1, illustrating a vent aperture in a bulkhead in accordance with one embodiment of the present disclosure.

FIG. 5 is a front perspective view of the exemplary bulkhead of FIG. 4 with a vent door illustrated in the open position in accordance with one embodiment of the present disclosure.

FIG. 6 is a rear perspective view of the exemplary air conditioner unit and bulkhead of FIG. 4 including a fan assembly for providing make-up air in accordance with one embodiment of the present disclosure.

FIG. 7 is a side cross sectional view of the exemplary air conditioner unit of FIG. 1.

FIG. 8 illustrates a method for operating an air conditioner unit in accordance with one embodiment of the present disclosure.

FIG. 9 is a plot of various operating parameters of an air conditioner unit changing over time as an occupant is sensed and then leaves the room according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

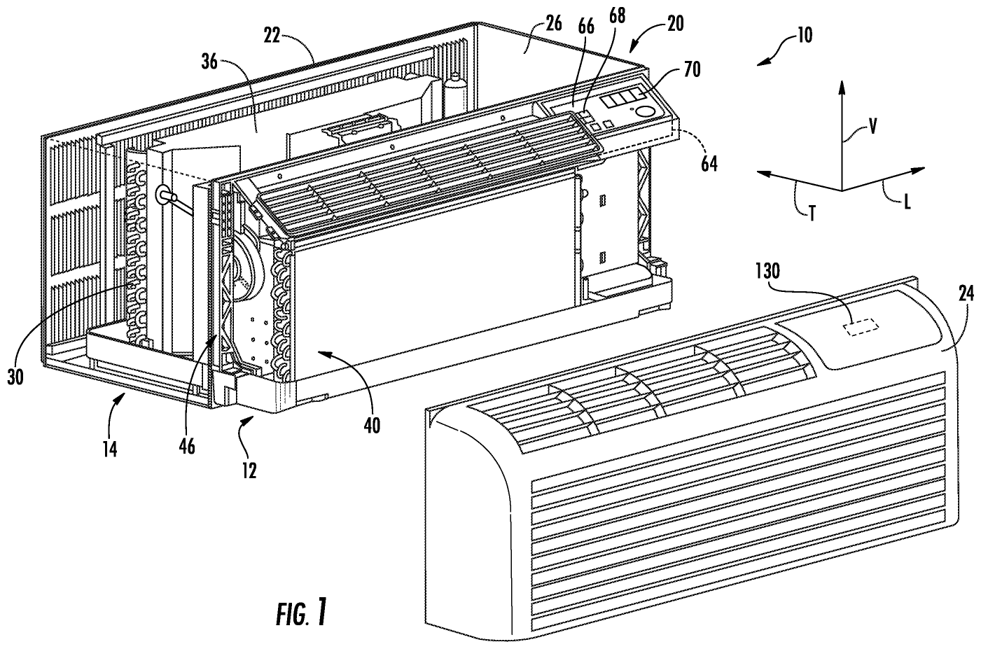

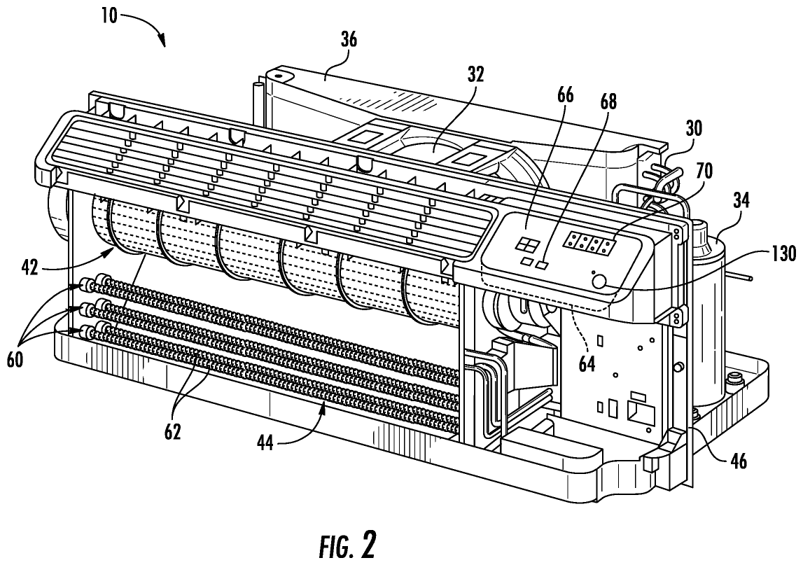

Referring now to FIGS. 1 and 2, an air conditioner unit 10 is provided. The air conditioner unit 10 is a one-unit type air conditioner, also conventionally referred to as a room air conditioner or a packaged terminal air conditioner (PTAC). The unit 10 includes an indoor portion 12 and an outdoor portion 14, and generally defines a vertical direction V, a lateral direction L, and a transverse direction T. Each direction V, L, T is perpendicular to each other, such that an orthogonal coordinate system is generally defined.

A housing 20 of the unit 10 may contain various other components of the unit 10. Housing 20 may include, for example, a rear grill 22 and a room front 24 which may be spaced apart along the transverse direction T by a wall sleeve 26. The rear grill 22 may be part of the outdoor portion 14, and the room front 24 may be part of the indoor portion 12. Components of the outdoor portion 14, such as an outdoor heat exchanger 30, an outdoor fan 32, and a compressor 34 may be housed within the wall sleeve 26. A fan shroud 36 may additionally enclose outdoor fan 32, as shown.

Indoor portion 12 may include, for example, an indoor heat exchanger 40, a blower fan or indoor fan 42, and a heating unit 44. These components may, for example, be housed behind the room front 24. Additionally, a bulkhead 46 may generally support and/or house various other components or portions thereof of the indoor portion 12, such as indoor fan 42 and the heating unit 44. Bulkhead 46 may generally separate and define the indoor portion 12 and outdoor portion 14.

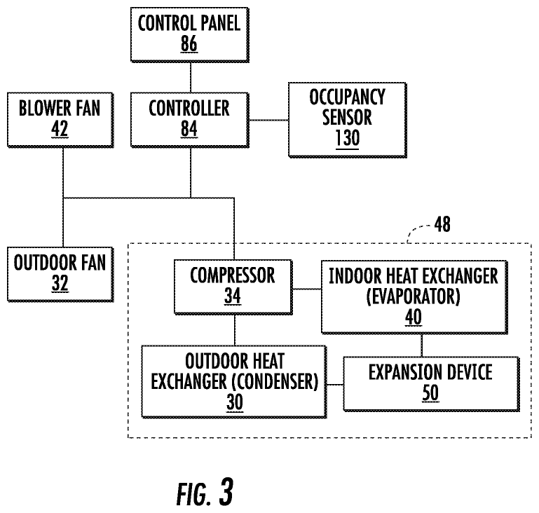

Outdoor and indoor heat exchangers 30, 40 may be components of a sealed system or refrigeration loop 48, which is shown schematically in FIG. 3. Refrigeration loop 48 may, for example, further include compressor 34 and an expansion device 50. As illustrated, compressor 34 and expansion device 50 may be in fluid communication with outdoor heat exchanger 30 and indoor heat exchanger 40 to flow refrigerant therethrough as is generally understood. More particularly, refrigeration loop 48 may include various lines for flowing refrigerant between the various components of refrigeration loop 48, thus providing the fluid communication there between. Refrigerant may thus flow through such lines from indoor heat exchanger 40 to compressor 34, from compressor 34 to outdoor heat exchanger 30, from outdoor heat exchanger 30 to expansion device 50, and from expansion device 50 to indoor heat exchanger 40. The refrigerant may generally undergo phase changes associated with a refrigeration cycle as it flows to and through these various components, as is generally understood. Suitable refrigerants for use in refrigeration loop 48 may include pentafluoroethane, difluoromethane, or a mixture such as R410a, although it should be understood that the present disclosure is not limited to such examples and rather that any suitable refrigerant may be utilized.

As is understood in the art, refrigeration loop 48 may be alternately operated as a refrigeration assembly (and thus perform a refrigeration cycle) or a heat pump (and thus perform a heat pump cycle). As shown in FIG. 3, when refrigeration loop 48 is operating in a cooling mode and thus performing a refrigeration cycle, the indoor heat exchanger 40 acts as an evaporator and the outdoor heat exchanger 30 acts as a condenser. Alternatively, when the assembly is operating in a heating mode and thus performs a heat pump cycle, the indoor heat exchanger 40 acts as a condenser and the outdoor heat exchanger 30 acts as an evaporator. The outdoor and indoor heat exchangers 30, 40 may each include coils through which a refrigerant may flow for heat exchange purposes, as is generally understood.

According to an example embodiment, compressor 34 may be a variable speed compressor. In this regard, compressor 34 may be operated at various speeds depending on the current air conditioning needs of the room and the demand from refrigeration loop 48. For example, according to an exemplary embodiment, compressor 34 may be configured to operate at any speed between a minimum speed, e.g., 1500 revolutions per minute (RPM), to a maximum rated speed, e.g., 3500 RPM. Notably, use of variable speed compressor 34 enables efficient operation of refrigeration loop 48 (and thus air conditioner unit 10), minimizes unnecessary noise when compressor 34 does not need to operate at full speed, and ensures a comfortable environment within the room.

Specifically, according to an exemplary embodiment, compressor 34 may be an inverter compressor. In this regard, compressor 34 may include a power inverter, power electronic devices, rectifiers, or other control electronics suitable for converting an alternating current (AC) power input into a direct current (DC) power supply for the compressor. The inverter electronics may regulate the DC power output to any suitable DC voltage that corresponds to a specific operating speed of compressor. In this manner compressor 34 may be regulated to any suitable operating speed, e.g., from 0% to 100% of the full rated power and/or speed of the compressor. This may facilitate precise compressor operation at the desired operating power and speed, thus meeting system needs while maximizing efficiency and minimizing unnecessary system cycling, energy usage, and noise.

In exemplary embodiments as illustrated, expansion device 50 may be disposed in the outdoor portion 14 between the indoor heat exchanger 40 and the outdoor heat exchanger 30. According to the exemplary embodiment, expansion device 50 may be an electronic expansion valve that enables controlled expansion of refrigerant, as is known in the art. More specifically, electronic expansion device 50 may be configured to precisely control the expansion of the refrigerant to maintain, for example, a desired temperature differential of the refrigerant across the indoor heat exchanger 40. In other words, electronic expansion device 50 throttles the flow of refrigerant based on the reaction of the temperature differential across indoor heat exchanger 40 or the amount of superheat temperature differential, thereby ensuring that the refrigerant is in the gaseous state entering compressor 34. In this regard, for example, the electronic expansion valve may generally be configured for controlling a differential temperature between an inlet and an outlet of the indoor heat exchanger 40. According to alternative embodiments, expansion device 50 may be a capillary tube or another suitable expansion device configured for use in a thermodynamic cycle.

According to the illustrated exemplary embodiment, outdoor fan 32 is an axial fan and indoor fan 42 is a centrifugal fan. However, it should be appreciated that according to alternative embodiments, outdoor fan 32 and indoor fan 42 may be any suitable fan type. In addition, according to an exemplary embodiment, outdoor fan 32 and indoor fan 42 are variable speed fans, e.g., similar to variable speed compressor 34. For example, outdoor fan 32 and indoor fan 42 may rotate at different rotational speeds, thereby generating different air flow rates. It may be desirable to operate fans 32, 42 at less than their maximum rated speed to ensure safe and proper operation of refrigeration loop 48 at less than its maximum rated speed, e.g., to reduce noise when full speed operation is not needed. In addition, according to alternative embodiments, fans 32, 42 may be operated to urge make-up air into the room.

According to the illustrated embodiment, indoor fan 42 may operate as an evaporator fan in refrigeration loop 48 to encourage the flow of air through indoor heat exchanger 40. Accordingly, indoor fan 42 may be positioned downstream of indoor heat exchanger 40 along the flow direction of indoor air and downstream of heating unit 44. Alternatively, indoor fan 42 may be positioned upstream of indoor heat exchanger 40 along the flow direction of indoor air and may operate to push air through indoor heat exchanger 40.

Heating unit 44 in exemplary embodiments includes one or more heater banks 60. Each heater bank 60 may be operated as desired to produce heat. In some embodiments as shown, three heater banks 60 may be utilized. Alternatively, however, any suitable number of heater banks 60 may be utilized. Each heater bank 60 may further include at least one heater coil or coil pass 62, such as in exemplary embodiments two heater coils or coil passes 62. Alternatively, other suitable heating elements may be utilized.

The operation of air conditioner unit 10 including compressor 34 (and thus refrigeration loop 48 generally) indoor fan 42, outdoor fan 32, heating unit 44, expansion device 50, and other components of refrigeration loop 48 may be controlled by a processing device such as a controller 64. Controller 64 may be in communication (via for example a suitable wired or wireless connection) to such components of the air conditioner unit 10. Controller 64 may include a memory and one or more processing devices such as microprocessors, CPUs or the like, such as general or special purpose microprocessors operable to execute programming instructions or micro-control code associated with operation of unit 10. The memory may represent random access memory such as DRAM, or read only memory such as ROM or FLASH. In one embodiment, the processor executes programming instructions stored in memory. The memory may be a separate component from the processor or may be included onboard within the processor.

Unit 10 may additionally include a control panel 66 and one or more user inputs 68, which may be included in control panel 66. The user inputs 68 may be in communication with the controller 64. A user of the unit 10 may interact with the user inputs 68 to operate the unit 10, and user commands may be transmitted between the user inputs 68 and controller 64 to facilitate operation of the unit 10 based on such user commands. A display 70 may additionally be provided in the control panel 66 and may be in communication with the controller 64. Display 70 may, for example be a touchscreen or other text-readable display screen, or alternatively may simply be a light that can be activated and deactivated as required to provide an indication of, for example, an event or setting for the unit 10.

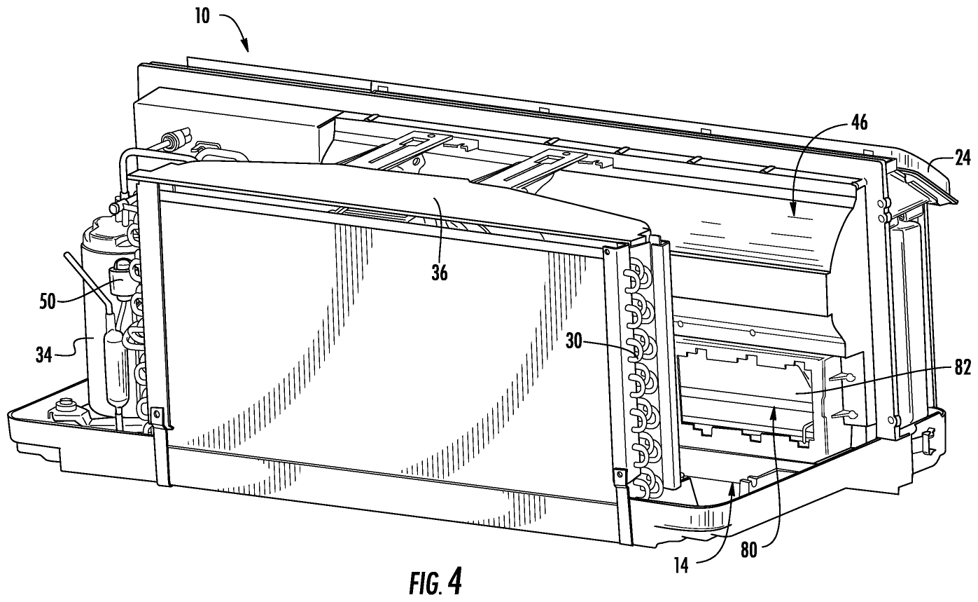

Referring briefly to FIG. 4, a vent aperture 80 may be defined in bulkhead 46 for providing fluid communication between indoor portion 12 and outdoor portion 14. Vent aperture 80 may be utilized in an installed air conditioner unit 10 to allow outdoor air to flow into the room through the indoor portion 12. In this regard, in some cases it may be desirable to allow outside air (i.e., “make-up air”) to flow into the room in order, e.g., to meet government regulations, to compensate for negative pressure created within the room, etc. In this manner, according to an exemplary embodiment, make-up air may be provided into the room through vent aperture 80 when desired.

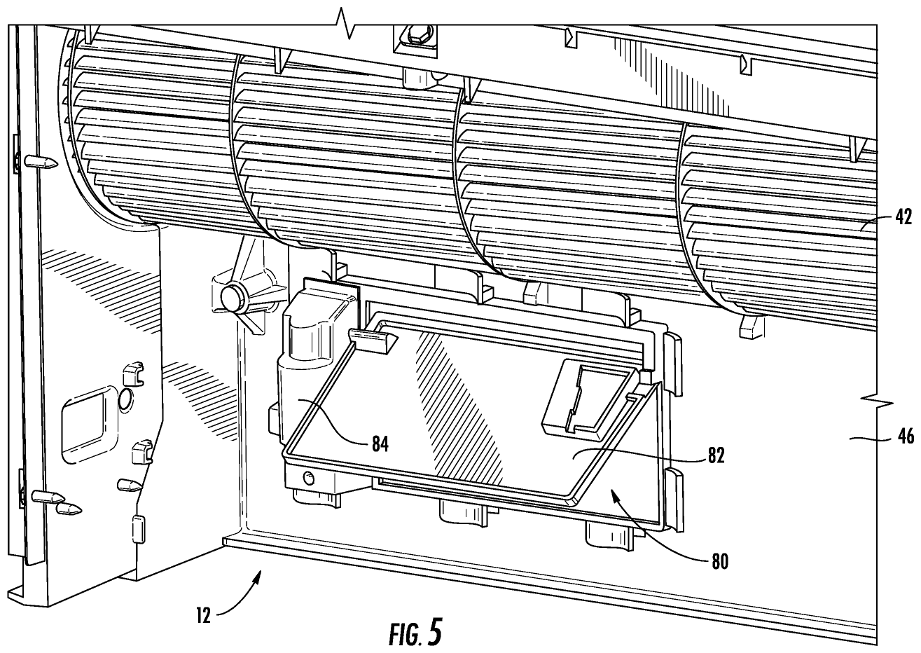

As shown in FIG. 5, a vent door 82 may be pivotally mounted to the bulkhead 46 proximate to vent aperture 80 to open and close vent aperture 80. More specifically, as illustrated, vent door 82 is pivotally mounted to the indoor facing surface of indoor portion 12. Vent door 82 may be configured to pivot between a first, closed position where vent door 82 prevents air from flowing between outdoor portion 14 and indoor portion 12, and a second, open position where vent door 82 is in an open position (as shown in FIG. 5) and allows make-up air to flow into the room. According to the illustrated embodiment vent door 82 may be pivoted between the open and closed position by an electric motor 84 controlled by controller 64, or by any other suitable method.

In some cases, it may be desirable to treat or condition make-up air flowing through vent aperture 80 prior to blowing it into the room. For example, outdoor air which has a relatively high humidity level may require treating before passing into the room. In addition, if the outdoor air is cool, it may be desirable to heat the air before blowing it into the room. Therefore, according to an exemplary embodiment of the present subject matter, unit 10 may further include an auxiliary sealed system that is positioned over vent aperture 80 for conditioning make-up air. The auxiliary sealed system may be a miniature sealed system that acts similar to refrigeration loop 48, but conditions only the air flowing through vent aperture 80. According to alternative embodiments, such as that described herein, make-up air may be urged through vent aperture 80 without the assistance of an auxiliary sealed system. Instead, make-up air is urged through vent aperture 80 may be conditioned at least in part by refrigeration loop 48, e.g., by passing through indoor heat exchanger 40. Additionally, the make-up air may be conditioned immediately upon entrance through vent aperture 80 or sequentially after combining with the air stream induced through indoor heat exchanger 40.

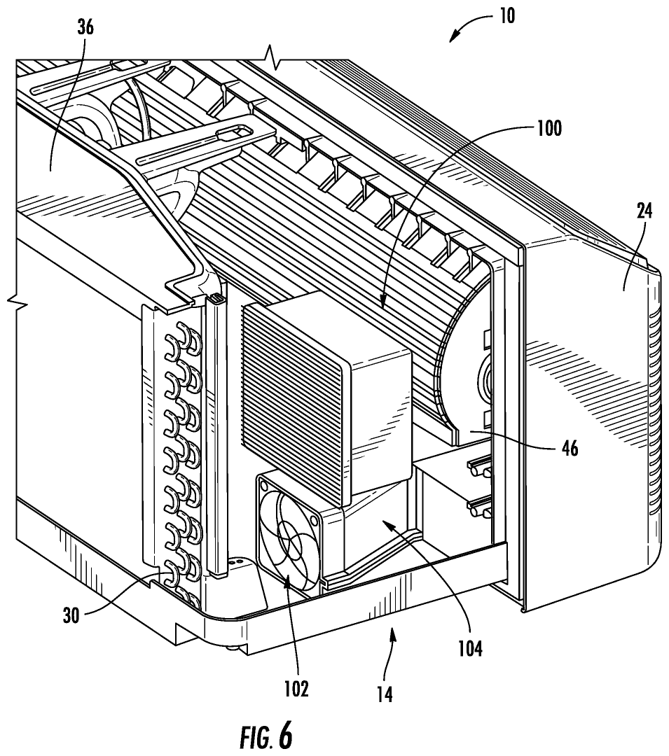

Referring now to FIG. 6, a fan assembly 100 will be described according to an exemplary embodiment of the present subject matter. According to the illustrated embodiment, fan assembly 100 is generally configured for urging the flow of makeup air through vent aperture 80 and into a conditioned room without the assistance of an auxiliary sealed system. However, it should be appreciated that fan assembly 100 could be used in conjunction with a make-up air module including an auxiliary sealed system for conditioning the flow of make-up air. As illustrated, fan assembly 100 includes an auxiliary fan 102 for urging a flow of make-up air through a fan duct 104 and into indoor portion 12 through vent aperture 80.

According to the illustrated embodiment, auxiliary fan 102 is an axial fan positioned at an inlet of fan duct 104, e.g., upstream from vent aperture 80. However, it should be appreciated that any other suitable number, type, and configuration of fan or blower could be used to urge a flow of makeup air according to alternative embodiments. In addition, auxiliary fan 102 may be positioned in any other suitable location within air conditioner unit 10 and auxiliary fan 102 may be positioned at any other suitable location within or in fluid communication with fan duct 104. The embodiments described herein are only exemplary and are not intended to limit the scope present subject matter.

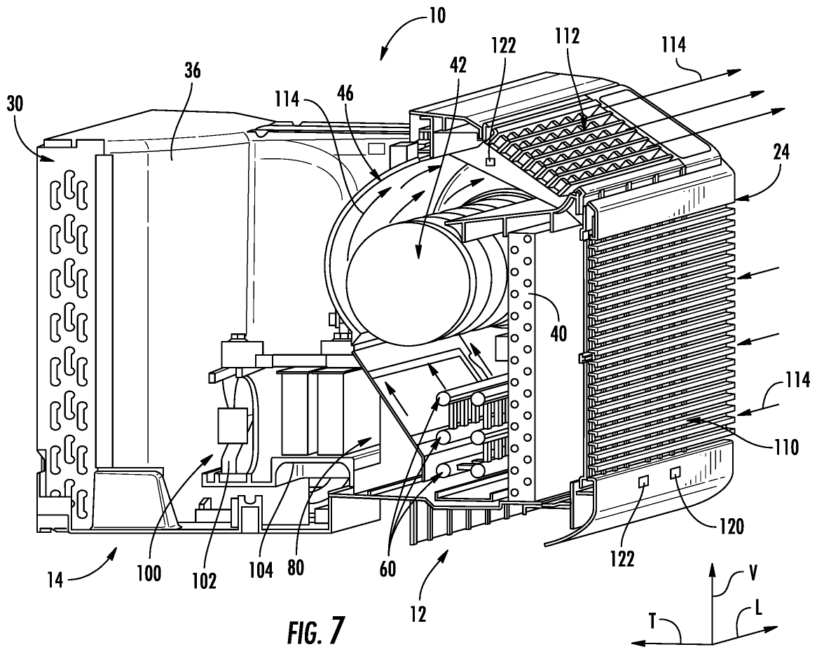

Referring now to FIG. 7, operation of unit 10 will be described according to an exemplary embodiment. More specifically, the operation of components within indoor portion 12 will be described during a cooling operation or cooling cycle of unit 10. To simplify discussion, the operation of auxiliary fan 102 for providing make-up air through vent aperture 80 will be omitted, e.g., as if vent door 82 were closed. Although a cooling cycle will be described, it should be further appreciated that indoor heat exchanger 40 and/or heating unit 44 be used to heat indoor air according to alternative embodiments. Moreover, although operation of unit 10 is described below for the exemplary packaged terminal air conditioner unit, it should be further appreciated that aspects the present subject matter may be used in any other suitable air conditioner unit, such as a heat pump or split unit system.

As illustrated, room front 24 of unit 10 generally defines an intake vent 110 and a discharge vent 112 for use in circulating a flow of air (indicated by arrows 114) throughout a room. In this regard, indoor fan 42 is generally configured for drawing in air 114 through intake vent 110 and urging the flow of air through indoor heat exchanger 40 before discharging the air 114 out of discharge vent 112. According to the illustrated embodiment, intake vent 110 is positioned proximate a bottom of unit 10 and discharge vent 112 is positioned proximate a top of unit 10. However, it should be appreciated that according to alternative embodiments, intake vent 110 and discharge vent 112 may have any other suitable size, shape, position, or configuration.

During a cooling cycle, refrigeration loop 48 is generally configured for urging cold refrigerant through indoor heat exchanger 40 in order to lower the temperature of the flow of air 114 before discharging it back into the room. Specifically, during a cooling operation, controller 64 may be provided with a target temperature, e.g., as set by a user for the desired room temperature. In general, components of refrigeration loop 48, outdoor fan 32, indoor fan 42, and other components of unit 10 operate to continuously cool the flow of air.

In order to facilitate operation of refrigeration loop 48 and other components of unit 10, unit 10 may include a variety of sensors for detecting conditions internal and external to the unit 10. These conditions can be fed to controller 64 which may make decisions regarding operation of unit 10 to rectify undesirable conditions or to otherwise condition the flow of air 114 into the room. For example, as best illustrated in FIG. 7, unit 10 may include an indoor temperature sensor 120 which is positioned and configured for measuring the indoor temperature within the room. In addition, unit 10 may include an indoor humidity sensor 122 which is positioned and configured for measuring the indoor humidity within the room. In this manner, unit 10 may be used to regulate the flow of air 114 into the room until the measured indoor temperature reaches the desired target temperature and/or humidity level.

As used herein, “temperature sensor” or the equivalent is intended to refer to any suitable type of temperature measuring system or device positioned at any suitable location for measuring the desired temperature. Thus, for example, temperature sensor 120 may each be any suitable type of temperature sensor, such as a thermistor, a thermocouple, a resistance temperature detector, a semiconductor-based integrated circuit temperature sensor, etc. In addition, temperature sensor 120 may be positioned at any suitable location and may output a signal, such as a voltage, to a controller that is proportional to and/or indicative of the temperature being measured. Although exemplary positioning of temperature sensors is described herein, it should be appreciated that unit 10 may include any other suitable number, type, and position of temperature, humidity, and/or other sensors according to alternative embodiments.

As used herein, the terms “humidity sensor” or the equivalent may be intended to refer to any suitable type of humidity measuring system or device positioned at any suitable location for measuring the desired humidity. Thus, for example, humidity sensor 122 may refer to any suitable type of humidity sensor, such as capacitive digital sensors, resistive sensors, and thermal conductivity humidity sensors. In addition, humidity sensor 122 may be positioned at any suitable location and may output a signal, such as a voltage, to a controller that is proportional to and/or indicative of the humidity being measured. Although exemplary positioning of humidity sensors is described herein, it should be appreciated that unit 10 may include any other suitable number, type, and position of humidity sensors according to alternative embodiments.

Now that the construction of air conditioner unit 10 and the configuration of controller 64 according to exemplary embodiments have been presented, an exemplary method 200 of operating a packaged terminal air conditioner unit will be described. Although the discussion below refers to the exemplary method 200 of operating air conditioner unit 10, one skilled in the art will appreciate that the exemplary method 200 is applicable to the operation of a variety of other air conditioning appliances. In exemplary embodiments, the various method steps as disclosed herein may be performed by controller 64 or a separate, dedicated controller.

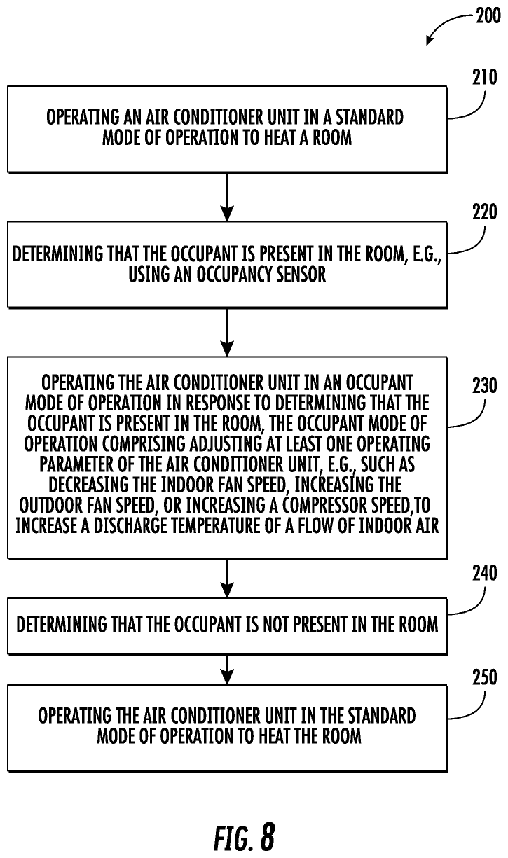

Referring now to FIG. 8, method 200 includes, at step 210, operating an air conditioner unit in a standard mode of operation to heat a room. In this regard, for example, the air conditioner unit may be a single-package vertical unit (SPVU), a package terminal air conditioner (PTAC), or any other suitable air conditioner unit. As described briefly above, such air conditioner units commonly discharge heated air into a room to raise the room temperature to a target temperature. In general, the “standard mode of operation” is generally intended to refer to the normal operating mode when an occupant is not present within the room. In this regard, the standard mode of operation may generally be a high-efficiency mode of operation where the heat pump operates to regulate the room temperature toward the target temperature but in a particularly energy-efficient manner.

As also explained above, this temperature regulation is commonly achieved by discharging indoor air at a temperature only slightly above the current room temperature, e.g., at discharge temperature below 80° Fahrenheit. However, the flow of indoor air being discharged at these relatively low temperatures may be perceived as cool to the occupant. Accordingly, aspects of the present subject matter are directed to manipulating the operation of an air conditioner unit in response to occupant presence for improved occupant comfort without unduly sacrificing energy efficiency.

In general, the standard mode of operation may be triggered by any suitable source, in any suitable manner, and may correspond with any suitable sealed system demand, as described below according to exemplary embodiments. In this regard, for example, a standard mode of operation may be initiated by a thermostat based at least in part on a difference between a measured temperature (e.g., as measured by indoor temperature sensor 120) and a temperature setpoint of the air-conditioned room. In this regard, if the measured temperature differs from the temperature set point by more than a predetermined amount, unit 10 may initiate a standard operating cycle to urge the measured temperature toward the temperature setpoint. According to exemplary embodiments, the operating cycle may also be directly initiated by a user of unit 10, e.g., via manipulation of control panel 66. Once triggered, the standard mode of operation may include selectively operating compressor 34, outdoor fan 32, indoor fan 42, expansion device 50, etc. to facilitate heat pump operation and the heating or cooling of indoor air 114.

Step 220 may generally include determining that an occupant is present in the room. In this regard, conditioner unit 10 may include an occupancy sensor 130 for determining room occupancy. In this regard, occupancy sensor 130 may be a motion sensor, an optical sensor, an acoustic sensor, or any other suitable device for detecting motion or activity within the room. In addition, step 220 of determining that an occupant is present in the room may include the use of any other suitable method for determining room occupancy. For example, air conditioner unit 10 may be operably coupled with a door sensor or the room access panel on the door such that occupancy may be determined based on the opening and/or closing of the room door. Other suitable means for detecting room occupancy are possible and within the scope the present subject matter.

Step 230 may include operating the air conditioner unit in an occupant mode of operation in response to determining that the occupant is present in the room. In this regard, air conditioner unit 10 may transition from the standard operating mode (e.g., the high-efficiency mode of operation) to the occupant mode of operation (e.g., the relatively lower efficiency and higher temperature mode of operation) upon detecting a room occupant. As explained above, this transition in operating mode may result in the discharge of indoor air at a temperature more suitable and desirable for direct occupant exposure.

In general, the “occupant mode of operation” is generally intended to refer to the operation of air conditioner unit while one or more occupants are present within the room being conditioned. In general, the occupant mode of operation may differ from the standard mode of operation in that at least one operating parameter of the air conditioner unit is varied to increase the discharge temperature of the flow of indoor air (e.g., flow of air 114).

In general, the operating parameter that is adjusted may be any suitable operating parameter of air conditioner unit 10 that is adjustable by controller 64 and that may affect the discharge temperature of indoor air. Exemplary operating parameter adjustments are described below. However, it should be appreciated that according to exemplary embodiments, one or all of these exemplary operating parameters may be adjusted simultaneously to achieve an increase in the discharge temperature of the flow of indoor air relative to that discharged in the standard mode of operation. In addition, it should be appreciated that additional operating parameter adjustments are possible and within the scope of the present subject matter.

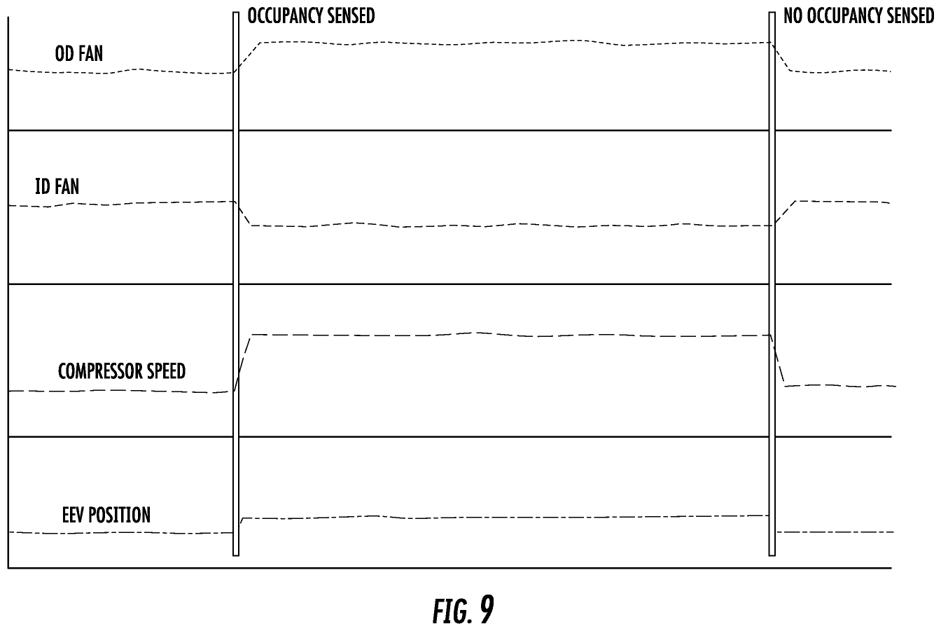

FIG. 9 illustrates a sequence of operating parameter adjustments that may be performed according to exemplary embodiments. For example, the operating parameter that is adjusted in the occupant mode of operation may be the indoor fan speed of indoor fan 42. In this regard, air flowing at a higher velocity may generally cause the air to feel cooler to the occupant, e.g., due to the increased rate of heat lost through convection and evaporation. By contrast, lower velocity air may feel warmer.

Accordingly, the indoor fan speed may be decreased in the occupant mode of operation relative to the standard mode of operation in order to increase the perceived temperature of the flow of indoor air. By contrast, according to alternative exemplary embodiments, air conditioner unit 10 may have and indoor fan speed that is fixed by a user of the appliance, e.g., via a setting on control panel 66 (e.g., such as a high fan speed, medium fan speed, or low fan speed setting). According to exemplary embodiments, the occupant mode of operation may include this preset indoor fan speed and may manipulate other operating parameters in order to increase the discharge temperature of the flow of indoor air.

Referring still to FIG. 9, according to an exemplary embodiment, the operating parameter that is adjusted in the occupant mode of operation may be the outdoor fan speed of outdoor fan 32. In this regard, increasing the outdoor fan speed may generally act to increase the saturated condensing pressure and/or temperature. In turn, this would pull more heat into the refrigerant passing through the outdoor heat exchanger. This additional thermal energy may then be extracted from the indoor heat exchanger, thereby raising the discharge temperature of the flow of indoor air. According to exemplary embodiments, the outdoor fan speed in the occupant mode of operation may be a maximum fan speed or a fan speed at 70%, 80%, 90%, or greater of the rated fan speed.

According to an exemplary embodiment, the operating parameter that is adjusted in the occupant mode of operation may be the compressor speed of the variable speed compressor 34. In this regard, increasing the speed of compressor 34 generally increases the heating capacity of refrigeration loop 48. Notably, this increase in heating capacity would lead to a faster heating cycle (e.g., the measured room temperature approaches the target room temperature more quickly), and the discharge temperature of the flow of indoor air would feel more comfortable to the room occupant. According to exemplary embodiments, the compressor speed in the occupant mode of operation may be between about 1500 and 4000 revolutions per minute, between about 2000 and 3500 revolutions per minute, between about 2500 and 3000 revolutions per minute, or any other suitable compressor speed that is elevated relative to the standard mode of operation.

As also shown in FIG. 9, the operating parameter that may be adjusted is a position of the electronic expansion valve 50. In this regard, when an occupant is sensed, the electronic expansion valve 50 may open slightly from its prior position to permit more refrigerant to flow therethrough. More refrigerant mass flow enables more cooling capacity on the evaporator side and more heating capacity on the condenser side. Operation of the compressor at a higher speed and opening the electronic expansion valve both enable more mass flow and thus greater heating capacity. Thus, manipulating both the compressor and expansion valve in concert to raise the mass flow and heating capacity is desirable, as the heating capacity may drop if only other adjustments are made. The increased heating capacity can be used during occupancy to raise indoor exhaust temperatures.

For example, the indoor fan and the outdoor fan may be used to affect the evaporative and condensing temperatures and pressures which can help with meeting the outlet temperature but may not satisfy the room temperature requirements. Moving the compressor to a higher speed and moving the EEV to the increase flow point ensures that there is superheat at the exit of the evaporator and the inlet into the compressor. The indoor and outdoor fan may then be adjusted to balance the two air flows to match the desired outlet temperature for occupancy comfort.

According to exemplary embodiments, all of the above-described operating parameter adjustments may happen together to keep air conditioner unit 10 running at a similar heating capacity for both vacancy and occupancy. In this regard, the middle segment of FIG. 9, which illustrated the adjustment when an occupant is present, these operating parameter adjustments allow the air conditioner unit 10 to increase the discharge temperature of the flow of indoor air 114 without causing the overall heating capacity to decrease.

In general, the operating parameter adjustments described above are intended to increase the discharge temperature of the flow of indoor air. In this regard, for example, the discharge temperature of the flow of indoor air in the standard mode of operation may be between about 70° F. and 90° F., between about 75° F. and 85° F., or less than about 80° F. By contrast, the discharge temperature of the flow of indoor air and the occupant mode of operation may be between about 90° F. and 110° F., between about 95° F. in 105° F., or greater than 100° F. Accordingly, the perceived temperature of the flow of discharge air may be significantly higher in the occupant mode of operation relative to the standard mode of operation.

For example, a temperature difference may be defined between the discharge temperature of the flow of indoor air and a target indoor temperature. During operation in a standard mode of operation, the air conditioner unit 10 may discharge the flow of indoor air at a temperature difference of less than 15° F., less than 10° F., less than 5° F., or less. By contrast, during the occupant mode of operation, the temperature difference between the flow of indoor air and the target indoor temperature may be between about 15° F. and 40° F., between about 20° F. and 30° F., or about 25° F.

Notably, when an occupant leaves the room or occupancy is no longer detected, it may be desirable to transition back to the more high-efficiency standard mode of operation. Accordingly, step 240 may include determining that the occupant is not present in the room and step 250 may include operating air conditioner unit in the standard mode of operation to heat the room while the occupant is absent. In this manner, overall energy efficiency of air conditioner unit 10 may be maintained while improving consumer satisfaction with the supply of air generated by air conditioner unit 10.

It should be appreciated that according to exemplary embodiments, both the standard mode of operation and the occupant mode of operation may include implementation of closed-loop feedback control algorithms such as a proportional control algorithm, a proportional-integral control algorithm (e.g., a PI controller), or a proportional-integral-derivative control algorithm (e.g., a PID controller). In general, the closed-loop feedback control algorithm may operate refrigeration loop 48 and fans 32, 42 to minimize a difference between the measured indoor temperature and a setpoint temperature. In this regard, implementation of the closed-loop feedback control algorithm may include obtaining an indoor temperature (e.g., using indoor temperature sensor 120), determining an error value between the indoor temperature and a setpoint temperature, and passing or inputting error value into the closed-loop feedback control algorithm as a control input that minimizes the error. Details regarding the operation of the closed-loop feedback control algorithm are generally well known in the art and further detailed discussion will be omitted here for brevity. It should be appreciated that the algorithm weightings may be adjusted depending on the mode of operation.

FIG. 8 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using unit 10 as an example, it should be appreciated that this method may be applied to operate any suitable air conditioner unit.

Aspects of the present subject matter are generally directed to improved methods of operating a heat pump air conditioner unit. Specifically, the operation of the heat pump system is generally set such that the exhaust stream of air into the room is typically pushed above 100° Fahrenheit when occupancy is sensed. To achieve this temperature, various operating parameter adjustments may be implemented, such as at least one of decreasing airflow through the indoor fan, increasing the outdoor fan speed, increasing the compressor speed, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An air conditioner unit for heating a room, the air conditioner unit comprising:
a refrigeration loop comprising an outdoor heat exchanger, an indoor heat exchanger, and an electronic expansion valve for controlling a differential temperature between an inlet and an outlet of the indoor heat exchanger;
a compressor operably coupled to the refrigeration loop and being configured to urge a flow of refrigerant through the refrigeration loop;
an indoor fan for urging a flow of indoor air through the indoor heat exchanger;
an outdoor fan for urging a flow of outdoor air through the outdoor heat exchanger; and
a controller operably coupled to the compressor, the controller being configured to:
operate the air conditioner unit in a standard mode of operation to heat the room;
determine that an occupant is present in the room; and
operate the air conditioner unit in an occupant mode of operation in response to determining that the occupant is present in the room, the occupant mode of operation comprising adjusting at least one operating parameter of the air conditioner unit to increase a discharge temperature of the flow of indoor air.

2. The air conditioner unit of claim 1, wherein the air conditioner unit further comprises:
a motion sensor, wherein determining that the occupant is present in the room comprises detecting motion with the motion sensor.

3. The air conditioner unit of claim 1, wherein operating the air conditioner unit in the occupant mode of operation comprises decreasing an indoor fan speed of the indoor fan relative the indoor fan speed in the standard mode of operation.

4. The air conditioner unit of claim 1, wherein operating the air conditioner unit in the occupant mode of operation comprises increasing an outdoor fan speed of the outdoor fan relative the outdoor fan speed in the standard mode of operation.

5. The air conditioner unit of claim 4, wherein the outdoor fan speed is a maximum fan speed in the occupant mode of operation.

6. The air conditioner unit of claim 1, wherein operating the air conditioner unit in the occupant mode of operation comprises increasing a compressor speed of the compressor relative the compressor speed in the standard mode of operation.

7. The air conditioner unit of claim 6, wherein the compressor speed is at least 2500 revolutions per minute in the occupant mode of operation.

8. The air conditioner unit of claim 1, wherein operating the air conditioner unit in the occupant mode of operation comprises adjusting the electronic expansion valve to increase a flow rate of refrigerant through the electronic expansion valve.

9. The air conditioner unit of claim 1, wherein operating the air conditioner unit in the occupant mode of operation comprises decreasing an indoor fan speed of the indoor fan relative the indoor fan speed in the standard mode of operation, increasing an outdoor fan speed of the outdoor fan relative the outdoor fan speed in the standard mode of operation, and increasing a compressor speed of the compressor relative the compressor speed in the standard mode of operation.

10. The air conditioner unit of claim 1, wherein the controller is further configured to:
determine that the occupant is not present in the room; and
operate the air conditioner unit in the standard mode of operation to heat the room.

11. The air conditioner unit of claim 1, wherein the discharge temperature of the flow of indoor air is less than 85° Fahrenheit when the air conditioner unit of operating in the standard mode of operation and is greater than 90° Fahrenheit when the air conditioner unit of operating in the occupant mode of operation.

12. The air conditioner unit of claim 1, wherein the discharge temperature of the flow of indoor air is less than 80° Fahrenheit when the air conditioner unit of operating in the standard mode of operation and is greater than 100° Fahrenheit when the air conditioner unit of operating in the occupant mode of operation.

13. The air conditioner unit of claim 1, wherein a temperature difference is defined between the discharge temperature of the flow of indoor air and a target indoor temperature, and wherein the temperature difference is less than 10° Fahrenheit when the air conditioner unit of operating in the standard mode of operation and is greater than 20° Fahrenheit when the air conditioner unit of operating in the occupant mode of operation.

14. The air conditioner unit of claim 1, wherein the air conditioner unit is a single-package vertical unit (SPVU) or a package terminal air conditioner (PTAC).

15. A method of operating an air conditioner unit, the air conditioning unit comprising a refrigeration loop, a compressor, an indoor fan, an outdoor fan, and an electronic expansion valve, the method comprising:
operating the air conditioner unit in a standard mode of operation to heat a room;
determining that an occupant is present in the room; and
operating the air conditioner unit in an occupant mode of operation in response to determining that the occupant is present in the room, the occupant mode of operation comprising adjusting at least one operating parameter of the air conditioner unit to increase a discharge temperature of a flow of indoor air.

16. The method of claim 15, wherein operating the air conditioner unit in the occupant mode of operation comprises decreasing an indoor fan speed of the indoor fan relative the indoor fan speed in the standard mode of operation.

17. The method of claim 15, wherein operating the air conditioner unit in the occupant mode of operation comprises increasing an outdoor fan speed of the outdoor fan relative the outdoor fan speed in the standard mode of operation.

18. The method of claim 15, wherein operating the air conditioner unit in the occupant mode of operation comprises increasing a compressor speed of the compressor relative the compressor speed in the standard mode of operation.

19. The method of claim 15, wherein operating the air conditioner unit in the occupant mode of operation comprises decreasing an indoor fan speed of the indoor fan relative the indoor fan speed in the standard mode of operation, increasing an outdoor fan speed of the outdoor fan relative the outdoor fan speed in the standard mode of operation, and increasing a compressor speed of the compressor relative the compressor speed in the standard mode of operation.

20. The method of claim 15, further comprising:
determining that the occupant is not present in the room; and
operating the air conditioner unit in the standard mode of operation to heat the room.
